(19) United States
(12) Patent Application Publication
(10) Pub. No.: US 2005/0038612 A1
(43) Pub. Date: Feb. 17, 2005

(54) Method for deriving true density of a pharmaceutical solid

(76) Inventor: Changquan C. Sun, Portage, MI (US)

Correspondence Address: WARNER-LAMBERT COMPANY, 2800 PLYMOUTH RD, ANN ARBOR, MI, 48105, US

(21) Appl. No.: 10/915,880

(22) Filed: Aug. 11, 2004

Related U.S. Application Data
(60) Provisional application No. 60/494,252, filed on Aug. 11, 2003.

(51) Int. Cl. G06F 19/00

(52) U.S. Cl. 702/32

(57) ABSTRACT

A method for deriving true density of a powder for compaction to prepare a pharmaceutical tablet comprises (a) preparing by compaction of the powder a plurality of tablets at different compaction pressures defining a range from low to high compaction pressures; (b) determining tablet density of tablets prepared at each compaction pressure to obtain compaction pressure versus tablet density data; and (c) fitting the data to a modified Heckel equation by a nonlinear regression procedure to yield a value for true density of the powder. The method can be applied to water-containing as well as substantially water-free powders and is useful in situations where helium pycnometry is unavailable or inapplicable.

### CROSS REFERENCE TO RELATED APPLICATIONS

This application claims the benefit of U.S. Provisional Application Ser. No. 60/494,252, filed Aug. 11, 2003.

### FIELD OF THE INVENTION

The present invention relates to a method for deriving true density of a pharmaceutical solid, more particularly such a solid in powder form that is to be compacted to prepare a pharmaceutical tablet.

### BACKGROUND OF THE INVENTION

Strength of a compact of a powder, for example a pharmaceutical tablet, can be described by such parameters as tensile strength, Young's modulus and indentation hardness, and is an important indicator of resistance of the compact to breakage, attrition or deformation. These strength-related parameters in turn depend on porosity of the compact. It is therefore important to know the porosity of a specimen tablet.

Porosity of a tablet can be calculated from the equation

$$ɛ = 1 - \frac{{ρ}_{tablet}}{{ρ}_{true}} \qquad ( 1 )$$

where ρ_{tablet} is the density of the tablet as calculated, for example, from the measured weight and volume of the tablet and ρₜᵣᵤₑ is the true density of the powder from which the tablet is prepared. Accurate determination of porosity therefore depends on accurate measurement of powder true density.

True density can be obtained using pycnometry, for example helium pycnometry, or by flotation density measurement, or from single crystal structure. Each of these techniques suffers drawbacks in particular situations.

Flotation density measurement is not suitable for powder mixtures, as are generally used in preparation of pharmaceutical tablets.

Single crystal structure is likewise unsuitable for powder mixtures, and furthermore is not routinely available. Even if available, single crystal structure is normally determined at lower than ambient temperature. True density calculated from single crystal structure data generated at low temperature tends to be higher than true density at ambient temperature, because most organic crystals exhibit volume expansion with increasing temperature.

For these reasons, helium pycnometry is the most widespread method for measuring powder true density in the pharmaceutical sciences. See, for example, Higuchi et al. (1952), J. Amer. Pharm. Assoc. (Sci. Ed.) 42, 194-200; Higuchi et al. (1954), J. Amer. Pharm. Assoc. (Sci. Ed.) 43, 685-689.

Helium pycnometry is relatively easy to perform and can be performed at ambient temperature. In helium pycnometry, change of pressure of a known amount of helium gas in a test cell is measured before and after loading a powder sample. This pressure change is used to calculate the volume of the powder sample assuming ideal gas behavior. Helium is used mainly because its small molecular size enables it to readily penetrate minute pores, crevices and fissures in powder particles, thus permitting accurate volume determination.

However, helium pycnometry has a significant drawback, particularly in the pharmaceutical arts. If the sample powder contains water, presence of water vapor in the test cell alters gas pressure in the cell and introduces error into calculation of true density. Therefore, to obtain accurate results, it is imperative to completely dry a test powder before loading the test cell. In the case of hydrated crystals and other water-containing drug and excipient materials, drying alters solid state form, and significant changes in true density can occur as a result. True density values measured following drying of a pharmaceutical powder can therefore lead to inaccurate calculation of porosity of a tablet prepared from that powder.

Because of the importance of accurate determination of porosity and the difficulties alluded to above in measuring true density of pharmaceutical solids, an improved method for deriving true density of such solids has been a long-felt need in the art. In particular, there exists a need for such a method that does not involve alteration of powder properties, as occurs for example during drying. A method that would accurately derive true density of a water-containing solid, such as a crystalline hydrate or a water-containing amorphous drug or excipient or a formulation for tableting, would represent a significant advance in the art.

### SUMMARY OF THE INVENTION

There is now provided a method for deriving true density of a powder for compaction to prepare a pharmaceutical tablet, the method comprising the steps of
(a) preparing by compaction of the powder a plurality of tablets at different compaction pressures defining a range from low to high compaction pressures;
(b) determining tablet density of tablets prepared at each compaction pressure to obtain compaction pressure versus tablet density data; and
(c) fitting the data to a modified Heckel equation by a nonlinear regression procedure to yield a value for true density of the powder.

The modified Heckel equation can be expressed as

$$P = \frac{1}{C} [ ( 1 - {ɛ}_{c} ) - \frac{{ρ}_{tablet}}{{ρ}_{true}} - {ɛ}_{c} ln ( \frac{1 - \frac{{ρ}_{tablet}}{{ρ}_{true}}}{{ɛ}_{c}} ) ] \qquad ( 2 )$$

or in a form substantially equivalent thereto, where P is compaction pressure, ρ_{tablet} is tablet density and C, ε_{c} and ρₜᵣᵤₑ are parameters derivable from the equation where C is a function related to deformability, ε_{c} is critical porosity (a measure of porosity at a critical compaction pressure above which the powder begins to gain rigidity or strength) and ρₜᵣᵤₑ is true density of the powder.

It is important to the method of the invention that data be generated on tablets prepared in both low and high compaction pressure ranges. A “low compaction pressure range” in the present context is one in which the slope of a compaction pressure versus tablet density curve approaches zero, i.e., small increases in compaction pressure are associated with large increases in tablet density. A “high compaction pressure range” in the present context is one in which the slope of a compaction pressure versus tablet density curve approaches infinity, i.e., large increases in compaction pressure have little further effect in increasing tablet density.

It is surprisingly found that ρₜᵣᵤₑ as derived by the method of the invention correlates extremely closely with ρₜᵣᵤₑ as determined traditionally by helium pycnometry, for substantially water-free powders. It is therefore contemplated that for water-containing powders, which as indicated above do not yield reliable values of ρₜᵣᵤₑ by helium pycnometry, values of ρₜᵣᵤₑ as derived herein are likewise accurate and meaningful, and can be used to estimate porosity of tablets prepared from such powders.

### BRIEF DESCRIPTION OF THE DRAWINGS

FIG. 1 is a graph showing nonlinear regression of compaction pressure versus tablet density data for powdered sodium chloride as described in Example 1 herein.

FIG. 2 is a graph showing correlation between true density (ρₜᵣᵤₑ) as derived by the method of the invention and as determined by helium pycnometry, for a variety of substantially water-free powders as detailed in Table 1 of Example 1 herein.

FIG. 3 is a graph showing nonlinear regression of compaction pressure versus tablet density data for powder Formulation A as described in Example 4 herein.

### DETAILED DESCRIPTION OF THE INVENTION

Numerous workers have developed equations attempting to describe change of porosity of a tablet as a function of compaction pressure. See Denny (2002), Powder Technology 127, 162-172. Such equations have been found suitable to describe porosity data in a certain range of compaction pressures for certain materials. However, these equations tend not to be suitable to describe data in both low and high compaction pressure ranges.

A modified Heckel equation of the form

$$P = \frac{1}{C} [ ɛ - {ɛ}_{c} - {ɛ}_{c} ln ( \frac{ɛ}{{ɛ}_{c}} ) ] \qquad ( 3 )$$

wherein the parameters P, C, ε and ε_{c} are as defined above, has been proposed by Kuentz & Leuenberger (1999), Journal of Pharmaceutical Science 88(2), 174-179, as being suitable to describe compaction data for a series of pharmaceutically useful polymers. Suitability of equation (3) in describing compaction data for some other pharmaceutical powders has been reported by the present inventor. Sun (2002), AAPS Pharm. Sci. 4, W4299.

Substituting equation (1), which describes ε terms Of ρ_{tablet} and ρₜᵣᵤₑ, into equation (3) yields the modified Heckel equation (2) used in the method of the present invention. Equation (2) enables true density of a powder ρₜᵣᵤₑ to be derived from compaction pressure (P) versus tablet density (ρ_{tablet}) data.

According to the present invention, therefore, compaction pressure versus tablet density data (sometimes abbreviated herein to “compaction data”) are collected for a powder of interest.

Any suitable compaction equipment can be used to prepare tablets from the powder at different compaction pressures. Illustratively, an automated Carver hydraulic press fitted with die and punches giving round, flat-faced tablets has been found to give good results. Compaction pressure P is recorded for each tablet or batch of tablets prepared.

Density of the resulting tablets can be calculated from the weight and volume of the tablets. Volume of tablets can be determined by a displacement method or, more conveniently, by measurement of tablet dimensions, for example in the case of a round, flat-faced tablet by measurement of diameter and thickness. Accurate volume as well as weight measurement is important to yield a suitably accurate value of tablet density (ρ_{tablet})

Compaction data are then fitted to equation (2) using a suitable nonlinear regression computation program. Illustratively, the nonlinear regression function of Origin 7.0 (Origin Lab Corp., Northampton, Mass.) has been found useful.

The method is suitable for deriving true density of powders useful in pharmacy, whether or not they contain substantial amounts of water. For example, the method provides a useful alternative to helium pycnometry in obtaining true density data for substantially water-free powders. Examples of such powders include crystalline salts, e.g., sodium chloride; sugars, e.g., sucrose, anhydrous lactose; other substantially water-free excipients, e.g., adipic acid, p-hydroxybenzoic acid anhydrate; and substantially water-free active pharmaceutical ingredients (APIs), e.g., acetaminophen, ibuprofen, theophylline anhydrate, etc. In a laboratory not having access to helium pycnometry but having a tablet press operable at defined compaction pressures, the present method therefore affords an option not previously available.

For powders that are not substantially water-free, the present method offers a more accurate and meaningful determination of true density than is possible by helium pycnometry, because of change in true density that occurs as a result of the drying that must necessarily be performed for helium pycnometry. Examples of such powders include hydrates of excipients, e.g., L-lysine hydrochloride dihydrate, p-hydroxybenzoic acid monohydrate, dibasic calcium phosphate dihydrate; and APIs, e.g., theophylline monohydrate. Many excipients widely used in pharmacy are not substantially water-free, including cellulose-based excipients such as microcrystalline cellulose. Powders comprising a mixture of materials, for example pharmaceutical powders for tableting, are especially important subjects for true density derivation by the present method.

### EXAMPLES

### Example 1

A study was conducted to validate the method of the invention by comparing true density as derived herein with true density as measured by helium pycnometry, for a range of substantially water-free powders of pharmaceutical interest.

For a first set of powders—acetaminophen, adipic acid, p-hydroxybenzoic acid anhydrate, S(+)-ibuprofen, potassium chloride (KCl), sodium bromide (NaBr), sodium chloride (NaCl), sucrose and theophylline anhydrate—round, flat-faced tablets were prepared by compaction using an automated Carver hydraulic press, Model 3888 (Carver, Inc., Wabash, Ind.). Lots of tablets were prepared at a range of compaction pressures from low to high as defined herein, using round punches with a diameter of 7.98 mm. Prior to preparation of each lot, the dies and punches were dusted with magnesium stearate. Compaction pressure P was recorded for each lot.

Tablet dimensions (for volume determination) and weight were measured at least 2 hours after compaction, and tablet density ρ_{tablet} was calculated from these measurements.

True density of the powders was determined using an AccuPyc 1330, model 1320 helium pycnometer (Micromeritics, Norcross, Ga.).

For a second set of powders, compaction and true density (by helium pycnometry) data were obtained from published literature. Data for three crystal forms of sulfamerazine were obtained from Sun & Grant (2001), Pharmaceutical Research 18, 274-280. Data for a series of formulations comprising 10% corn starch were obtained from Higuchi et al. (1952), op. cit. These formulations further comprised aspirin, aspirin+lactose, lactose, sulfadiazine or sulfathiazole. Rigorous drying of solids was reportedly performed in generating these data.

Compaction pressure versus tablet density data for each powder were fitted to the modified Heckel equation (2) above using the nonlinear regression function of Origin 7.0, to yield a true density ρₜᵣᵤₑ value for the powder.

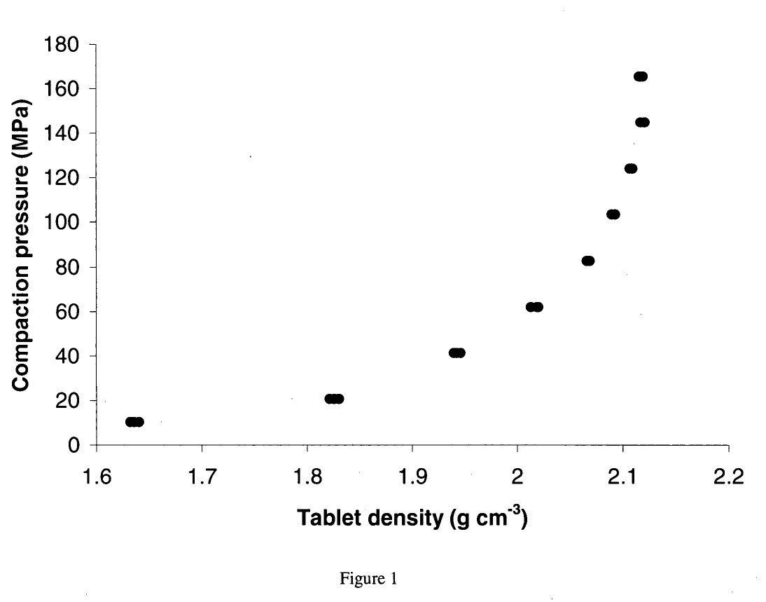

The fit of the data to equation (2) was found to be good for all powders (R²>0.97 in all cases). An illustrative data fitting plot, for NaCl, is shown in FIG. 1.

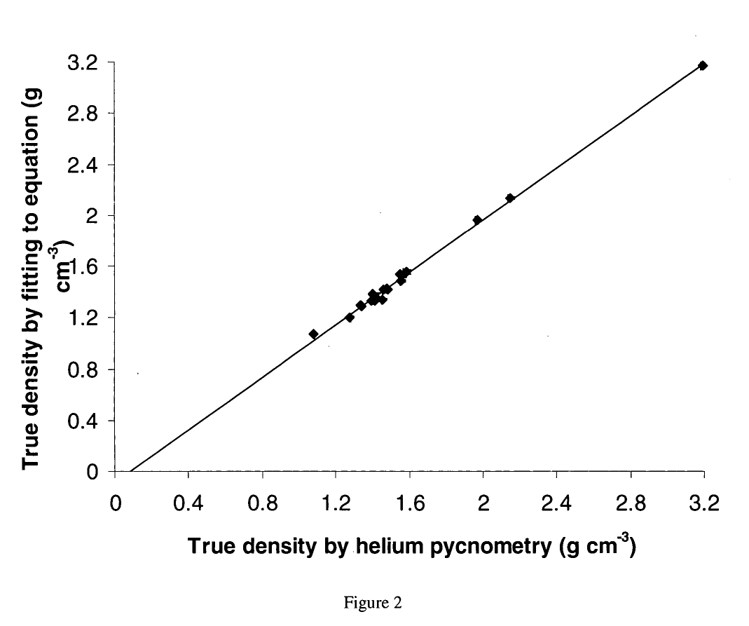

The ρₜᵣᵤₑ value derived by fitting to the modified Heckel equation was then compared with the ρₜᵣᵤₑ value determined by helium pycnometry. As shown in Table 1 and illustrated in FIG. 2, a very close correlation between the two values Of ρₜᵣᵤₑ was obtained.

It is concluded that the method of the invention yields a value of ρₜᵣᵤₑ that, for a substantially water-free powder, can be used without significant error in determination of tablet porosity and prediction of tablet strength. The method is therefore validated and can reliably be used in situations where helium pycnometry is not available. The method is also believed to be valid where helium pycnometry cannot generate meaningful data, as in the case of water-containing powders, because there is no fundamental difference between water-free and water-containing solids as far as mechanical properties and compaction behavior are concerned.

TABLE 1
Data derived by fitting compaction data to equation (2) for
substantially water-free powders

| | ρₜᵣᵤₑ by | Data derived from equation fitting | | | |
|---|---|---|---|---|---|
| | helium pycnometry | ρₜᵣᵤₑ | 1/C | | |
| Powder | g cm⁻³ | g cm⁻³ | MPa | 1 − ε_{c} | R² |
| acetaminophen | 1.279 ± 0.002 | 1.205 ± 0.005 | 651 ± 91 | 0.808 ± 0.006 | 0.997 |
| adipic acid | 1.342 ± 0.002 | 1.290 ± 0.002 | 324 ± 70 | 0.828 ± 0.018 | 0.991 |
| p-hydroxybenzoic | 1.454 ± 0.003 | 1.341 ± 0.004 | 206 ± 19 | 0.531 ± 0.016 | 0.998 |
| acid anhydrate | | | | | |
| S(+)-ibuprofen | 1.082 ± 0.004 | 1.071 ± 0.002 | 413 ± 150 | 0.890 ± 0.020 | 0.983 |
| KCl | 1.972 ± 0.000 | 1.963 ± 0.002 | 32.5 ± 8.2 | 0.02 ± 0.17 | 0.995 |
| NaBr | 3.192 ± 0.001 | 3.172 ± 0.009 | 161 ± 75 | 0.52 ± 0.14 | 0.973 |
| NaCl | 2.147 ± 0.001 | 2.134 ± 0.007 | 105 ± 30 | 0.541 ± 0.069 | 0.979 |
| sucrose | 1.581 ± 0.002 | 1.546 ± 0.009 | 799 ± 90 | 0.764 ± 0.003 | 0.999 |
| theophylline | 1.463 ± 0.007 | 1.421 ± 0.005 | 232 ± 22 | 0.569 ± 0.013 | 0.998 |
| anhydrate | | | | | |
| sulfamerazine | | | | | |
| (Form I) | 1.335 ± 0.004 | 1.297 ± 0.001 | 198 ± 10 | 0.653 ± 0.008 | 0.999 |
| (Form IIa) | 1.415 ± 0.005 | 1.335 ± 0.003 | 213 ± 11 | 0.528 ± 0.008 | 0.999 |
| (Form (IIb) | 1.415 ± 0.003 | 1.333 ± 0.002 | 244 ± 13 | 0.591 ± 0.008 | 0.999 |
| aspirin + | 1.404 | 1.382 ± 0.006 | 781 ± 417 | 0.795 ± 0.051 | 0.985 |
| corn starch | | | | | |
| aspirin + lactose + | 1.485 | 1.420 ± 0.001 | 437 ± 43 | 0.669 ± 0.016 | 0.999 |
| corn starch | | | | | |
| lactose + | 1.552 | 1.538 ± 0.009 | 637 ± 84 | 0.542 ± 0.018 | 0.999 |
| corn starch | | | | | |
| sulfadiazine + | 1.554 | 1.490 ± 0.007 | 422 ± 130 | 0.579 ± 0.060 | 0.994 |
| corn starch | | | | | |
| sulfathiazole | 1 579 | 1.546 ± 0.008 | 291 ± 76 | 0.420 ± 0.073 | 0.993 |
| corn starch | | | | | |

While the correlation between values of ρₜᵣᵤₑ as determined by the two methods was extremely close, as shown in FIG. 2, the values derived by the method of the invention were in this study consistently slightly lower than those obtained by helium pycnometry. It is believed, without being bound by theory, that a small amount of surface-associated water in the powders could have led to a slightly elevated value of ρₜᵣᵤₑ as measured by helium pycnometry. In any case, the differences are too small to be of practical concern.

### Example 2

A study was conducted to further validate the method of the invention by comparing true density as derived herein with true density as measured from crystal data and by the flotation density method, for a range of hydrated crystalline materials of pharmaceutical interest. True density was also measured by helium pycnometry, although it was known in advance that this method would yield artificially high values of true density for the hydrated materials of this study, for reasons mentioned above.

True density of three hydrates, as determined by flotation and from crystal data, was obtained from published literature. Data for L-lysine hydrochloride dihydrate were obtained from Wright & Marsh (1962), Acta Crystallographica 15, 54-64. Data for theophylline monohydrate were obtained from Sutor (1958), Acta Crystallographica 11, 83-87. Data for p-hydroxybenzoic acid monohydrate were obtained from Colapietro et al. (1979), Acta CrystallographicaB35, 2177-2180.

True density of the same three hydrates was determined by helium pycnometry and derived by fitting compaction data to the modified Heckel equation as described in Example 1. Results are shown in Table 2.

TABLE 2
True densities of hydrates by various methods

| | ρₜᵣᵤₑ (g cm⁻³) | | | |
|---|---|---|---|---|
| | | | | by fitting |
| | by | from | | to |
| | flotation | crystal | by helium | equation |
| Material | method | data | pycnometry | (2) |
| L-lysine HCl dihydrate | 1.250 | 1.259 | 1.270 | 1.246 |
| theophylline | 1.452 | 1.456 | 1.522 | 1.428 |
| monohydrate | | | | |
| p-hydroxybenzoic acid | 1.398 | 1.398 | 1.770 | 1.355 |
| monohydrate | | | | |

Compared with helium pycnometry, the method of the invention yielded ρₜᵣᵤₑ values for hydrates that were in much closer agreement with published measurements obtained using the flotation method or crystal data. The advantage of the present method over helium pycnometry was especially great for theophylline monohydrate and p-hydroxybenzoic acid monohydrate. Without being bound by theory, it is believed that this is a reflection of looser binding of water in crystals of these materials than in crystals of L-lysine hydrochloride dihydrate, resulting in especially inaccurate results by helium pycnometry.

### Example 3

It is well known that powders of a given material having different particle sizes and shapes consolidate differently under compaction pressure. See Sun & Grant (2001), International Journal of Pharmacy 215, 221-228; Sun & Grant (2001), Journal of Pharmaceutical Science 90, 567-577. When particle sizes or shapes are different, therefore, different compaction pressure versus tablet density data will be generated. Since true density is a material property that depends only on the internal structure of a solid and not on size or shape of particles, a reliable method should yield similar values of true density for differently sized or shaped particles of a material.

This aspect of reliability of the present method was tested by comparing results obtained for two particle size fractions of sulfamerazine Form II, and for three lots of L-lysine hydrochloride dihydrate differing in particle size and/or shape. The procedure was as described in Example 1. Raw data for L-lysine hydrochloride dihydrate were obtained from Sun & Grant (2001), Journal of Pharmaceutical Science 90, 567-577. Results are shown in Table 3.

TABLE 3
True density derived from fitting compaction data to equation (2)
for powders having different particle size and/or shape

| | | particle | |
|---|---|---|---|
| Material | particle size | shape | ρₜᵣᵤₑ (g cm⁻³) |
| sulfamerazine Form II | 1-15 μm | | 1.335 ± 0.002 |
| | 10-40 μm | | 1.333 ± 0.002 |
| L-lysine HCI monohydrate | 355-595 μm | plates | 1.236 ± 0.007 |
| | 355-595 μm | prisms | 1.246 ± 0.007 |
| | 850-1000 μm | prisms | 1.243 ± 0.008 |

The results of this study demonstrated the method of the invention to be highly robust in providing consistent values for ρₜᵣᵤₑ regardless of particle size or shape of the powder tested.

### Example 4

A study was conducted to extend the method of the invention to a range of water-containing powders of pharmaceutical interest. Procedures were as described in Example 1, except that for Formulations A and B as defined below the dies and punches were not dusted with magnesium stearate. Both these formulations contained magnesium stearate as a lubricant.

The materials tested were dibasic calcium phosphate dihydrate, p-hydroxybenzoic acid monohydrate, microcrystalline cellulose, theophylline monohydrate, and Formulations A and B. Formulation A contained 22.5% by weight coarse microcrystalline cellulose, 50% by weight compressible sucrose, 20% by weight artificial beef flavor, and small amounts of disintegrant, glidant and lubricant (magnesium stearate). Formulation B was similar but with lactose monohydrate from a sprayed process replacing the compressible sucrose. Also included in the study was L-lysine hydrochloride dihydrate in plate and prism form, based on the raw data referenced in Example 3.

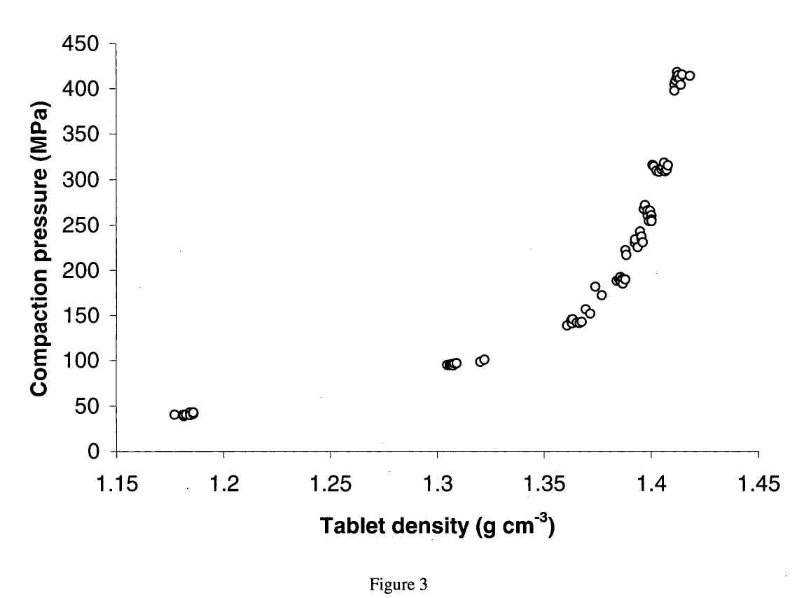

The fit of the data to equation (2) was found to be good for all powders (R²>0.96 in all cases). An illustrative data fitting plot, for Formulation A, is shown in FIG. 3.

The ρₜᵣᵤₑ value derived by fitting to the modified Heckel equation was compared with the ρₜᵣᵤₑ value determined by helium pycnometry. As shown in Table 4, the two values of ρₜᵣᵤₑ were poorly correlated, the method of the present invention generally yielding a value significantly lower than that obtained by helium pycnometry. It being known that helium pycnometry yields artificially elevated values of ρₜᵣᵤₑ for water-containing powders, it is believed that the values obtained by the present method are more accurate and meaningful.

TABLE 4
Data derived by fitting compaction data to equation (2) for
water-containing powders

| | ρₜᵣᵤₑ by | Data derived from equation fitting | | | |
|---|---|---|---|---|---|
| | helium pycnometry | ρₜᵣᵤₑ | 1/C | | |
| Powder | g cm⁻³ | g cm⁻³ | MPa | 1 − ε_{c} | R² |
| dibasic calcium | 2.369 ± 0.001 | 2.128 ± 0.033 | 889 ± 435 | 0.594 ± 0.066 | 0.989 |
| phosphate dihydrate | | | | | |
| p-hydroxybenzoic | 1.770 ± 0.060 | 1.355 ± 0.002 | 58.7 ± 10.0 | 0.246 ± 0.065 | 0.994 |
| acid monohydrate | | | | | |
| microcrystalline | 1.954 ± 0.020 | 1.353 ± 0.002 | 94.4 ± 11.7 | 0.492 ± 0.035 | 0.995 |
| cellulose | | | | | |
| theophylline | 1.522 ± 0.007 | 1.428 ± 0.002 | 96.9 ± 5.7 | 0.416 ± 0.017 | 0.999 |
| monohydrate | | | | | |
| Formulation A | 1.520 ± 0.002 | 1.422 ± 0.002 | 351 ± 61 | 0.646 ± 0.034 | 0.964 |
| Formulation B | 1.514 ± 0.002 | 1.440 ± 0.003 | 400 ± 77 | 0.641 ± 0.035 | 0.968 |
| L-lysine HCl | 1.268 ± 0.005 | 1.236 ± 0.007 | 613 ± 60 | 0.701 ± 0.003 | 0.999 |
| dihydrate (plates) | | | | | |
| L-lysine HCl | 1.263 ± 0.004 | 1.246 ± 0.007 | 667 ± 64 | 0.710 ± 0.003 | 0.999 |
| dihydrate (prisms) | | | | | |

Application of the present method for determining true density requires an assumption that no change in solid internal structure of the powder occurs during compaction. If, for example, polymorph conversion or dehydration occurs during tableting, it is possible that accurate powder density values will be difficult to obtain, even with the present method. Fortunately, solid state transformation induced by tableting is a rare phenomenon, and if it does occur it is usually very limited.

It will also be understood that the present method is not appropriate for pure materials such as magnesium stearate that do not form intact tablets. However, intact tablets can generally be prepared by including a binder such as microcrystalline cellulose. If the true density of a mixture of a poorly tableting material and a binder is derived by the method of the invention, true density of the poorly tableting material itself can be calculated using the following equation:

$${ρ}_{1} = \frac{{ρ}_{1 + 2} \cdot {ρ}_{2} {x}_{1}}{{ρ}_{2} + {ρ}_{1 + 2} + {ρ}_{1 + 2} {x}_{1}} \qquad ( 4 )$$

where ρ₁ is the true density of the poorly tableting material, ρ₂ is the true density of the binder, ρ₁₊₂ is the true density of the mixture and x₁ is the weight fraction of the poorly tableting material in the mixture.

1. A method for deriving true density of a powder for compaction to prepare a pharmaceutical tablet, the method comprising the steps of
(a) preparing by compaction of the powder a plurality of tablets at different compaction pressures defining a range from low to high compaction pressures;
(b) determining tablet density of tablets prepared at each compaction pressure to obtain compaction pressure versus tablet density data; and
(c) fitting the data to a modified Heckel equation by a nonlinear regression procedure to yield a value for true density of the powder;
wherein the modified Heckel equation is of the form
$$P = \frac{1}{C} [ ( 1 - {ɛ}_{c} ) - \frac{{ρ}_{tablet}}{{ρ}_{true}} - {ɛ}_{c} ln ( \frac{1 - \frac{{ρ}_{tablet}}{{ρ}_{true}}}{{ɛ}_{c}} ) ]$$
or a form substantially equivalent thereto, where P is compaction pressure, ρ_{tablet} is tablet density and C, ε_{c} and ρₜᵣᵤₑ are parameters derivable from the equation where C is a function related to deformability, ε_{c} is critical porosity and ρₜᵣᵤₑ is true density of the powder.

2. The method of claim 1 wherein the powder is not substantially water-free.

3. The method of claim 1 wherein the powder comprises a hydrate.

4. The method of claim 1 wherein the powder comprises an excipient that is not substantially water-free.
